(19) United States
(12) Patent Application Publication
(10) Pub. No.: US 2013/0078054 A1
(43) Pub. Date: Mar. 28, 2013

(54) HYBRID COLLAR FOR FASTENING SYSTEMS

(71) Applicants: Haylock Luke, Culver City, CA (US); Hasim Mulazimoglu, Buena Park, CA (US); Rodrigo Pinheiro, Riverside, CA (US)

(72) Inventors: Haylock Luke, Culver City, CA (US); Hasim Mulazimoglu, Buena Park, CA (US); Rodrigo Pinheiro, Riverside, CA (US)

(21) Appl. No.: 13/427,080

(22) Filed: Mar. 22, 2012

Related U.S. Application Data
(60) Provisional application No. 61/467,002, filed on Mar. 24, 2011.

(51) Int. Cl. F16B 29/00

(52) U.S. Cl. CPC F16B 29/00
USPC 411/511

(57) ABSTRACT

A collar includes a collar body having a flange and a bearing surface, and a base element attached to the collar body. The base element includes a base portion that covers the bearing surface of the collar body, and a securing portion that is joined to the flange of the collar body. The base element can be a flat base element, a ridge base element, or a swivel base element. The securing portion can be crimped onto the flange of the collar body. The collar body is made from a first material and the base element is made from a second material that is galvanically compatible with the first material. The first material may be aluminum or an aluminum alloy, while the second material may be steel, a steel alloys, titanium, or a titanium alloy. The collar is adapted to be installed on a structure made of a composite material.

### CROSS-REFERENCE TO RELATED APPLICATION

This application is a Section 111(a) application relating to and claims the benefit of commonly owned, co-pending U.S. Provisional Application Ser. No. 61/467,002 entitled “HYBRID COLLAR FOR FASTENING SYSTEMS”, filed Mar. 24, 2011, the entirety of which is incorporated herein by reference.

### FIELD OF THE INVENTION

The present invention relates to a collar for a fastening system and, more particularly, a hybrid collar for protection from galvanic corrosion between the collar and a structure.

### BACKGROUND OF THE INVENTION

The use of composite materials, such as carbon fiber reinforced plastics (CFRP), is becoming more common in the aerospace industry as advancements on composite technologies increase. A significant portion of a composite structure is fabricated as near net-shape, but it is drilled in order to facilitate the joining of components by using mechanical fasteners. One of the most essential criteria for choosing fasteners for aircraft structures is the galvanic corrosion compatibility between the fasteners and the joined components.

### SUMMARY OF THE INVENTION

In an embodiment, a collar for a fastening system includes a collar body having a first end, a second end opposite the first end, and a flange located at the second end and having a bearing surface; and a base element attached to the collar body, the base element including a base portion that covers the bearing surface of the collar body, and a securing portion that is joined to the flange of the collar body. In an embodiment, the collar body is made from a first material and the base element is made from a second material that is galvanically compatible with the first material. In an embodiment, the first material is selected from the group consisting of aluminum and aluminum alloys. In an embodiment, the second material is selected from the group consisting of steel, steel alloys, titanium, and titanium alloys.

In an embodiment, the securing portion of the base element is crimped on the flange of the collar body. In an embodiment, the collar body includes an aperture extending from the first end to the second thereof and forming an inner wall, and wherein the base element includes a sealing portion that extends into the aperture of the collar body and covers a portion of the inner wall. In an embodiment, the base element includes a swivel base element that is adapted to rotate relative to the collar body. In an embodiment, the collar is adapted to be installed on a structure made of a composite material.

In an embodiment, the collar has a coating that includes an organic material and a non-conductive filler. In an embodiment, the organic material is a polymer material, and the non-conductive filler is selected from the group consisting of aluminum pigmented paint, chromated paint, and sol-gel coatings. In an embodiment, the coating is applied to every portion of the collar body. In an embodiment, the coating is be applied on the collar body selectively.

In an embodiment, the collar is a threaded collar. In another embodiment, the collar is a swage collar.

In an embodiment, a collar body having a first end and a second end opposite the first end, the collar body being made from a first material; and a flange located at the second end of the collar body, the flange being made from a second material that is galvanically compatible with the first material. In an embodiment, the collar body and the flange are formed integrally with one another. In an embodiment, the first material is selected from the group consisting of aluminum and aluminum alloys. In an embodiment, the second material is selected from the group consisting of steel, steel alloys, titanium, and titanium alloys.

### BRIEF DESCRIPTION OF THE DRAWINGS

For a more complete understanding of the present invention, reference is made to the following detailed description of exemplary embodiments considered in conjunction with the accompanying drawings, in which:

FIG. 1 is a cross-sectional view of an embodiment of a lockbolt fastener system;

FIG. 2A is a partially sectioned perspective view of an embodiment of a hybrid collar adapted for use in the fastener system shown in FIG. 1, the collar including a flat base element;

FIG. 2B is a partially sectioned perspective view of another embodiment of a hybrid collar including a ridge base element;

FIG. 2C is a partially sectioned perspective view of another embodiment of a hybrid collar including a swivel base element;

FIG. 2D is a partially sectioned perspective view of another embodiment of a hybrid collar including an integrally formed flange;

FIG. 3 is a graph showing a comparison of specific tensile strength (UTS/density) of various collar materials;

FIG. 4 is a perspective view of an embodiment of a plurality of hybrid collars installed on a carbon fiber reinforced plastic (CFRP) structure;

FIG. 5 is a micrograph showing a functional gradient microstructure of hybrid collar achieved by in-situ cold working during fastener installation;

FIG. 6 is a graph illustrating the tensile strength of an aluminum hybrid collar versus a titanium collar showing equivalent ultimate strength; and

FIG. 7 are perspective views of an embodiment of hybrid collars tested with composite plate after salt spray corrosion testing.

### DETAILED DESCRIPTION OF THE DRAWINGS

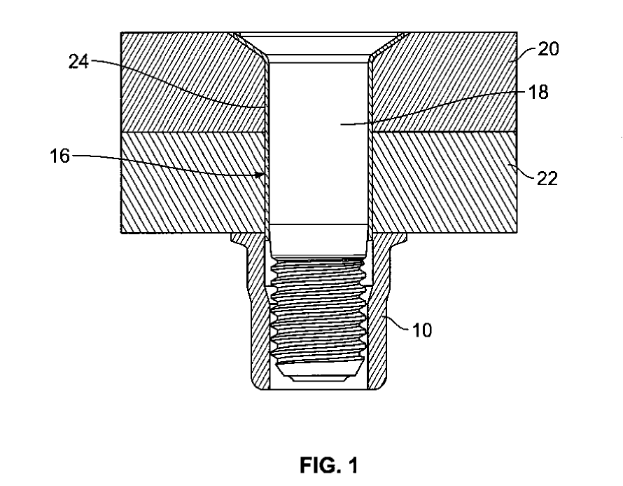

In an embodiment, a hybrid collar 10 is adapted to prevent galvanic corrosion and reduce weight as compared to a conventional titanium lockbolt collar. In an embodiment, the collar 10 combines a collar body 12 with a galvanically compatible base element 14. In an embodiment, the collar 10 is a lockbolt collar with a controlled swaging feature and used in a fastener assembly 16 having a threaded pin 18 as illustrated in FIG. 1, for fastening a plurality of workpieces 20, 22. In an embodiment, the fastener assembly 16 includes a sleeve 24 inserted into aligned holes of the workpieces 20, 22, and is sized and shaped to receive the pin 18. In an embodiment, the collar 10 is used in connection with aerospace applications, such as aircraft. In other embodiments, the collar 10 can be used in other applications and fields.

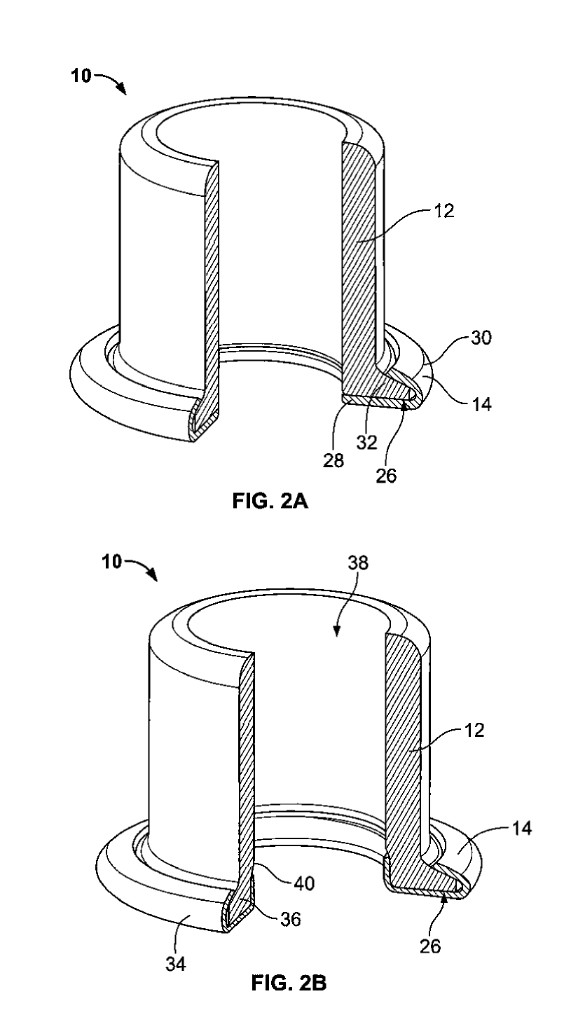

Referring to FIGS. 2A through 2C, the collar 10 includes the collar body 12, which is relatively soft and deformable, and a galvanically compatible base element 14. In an embodiment, the base element 14 is a washer which is suitable for composite structures, as shown in FIGS. 2A through 2C. In another embodiment, the collar 10 includes only the soft, deformable collar body 12, as shown in FIG. 2D, which is suitable for metallic structures.

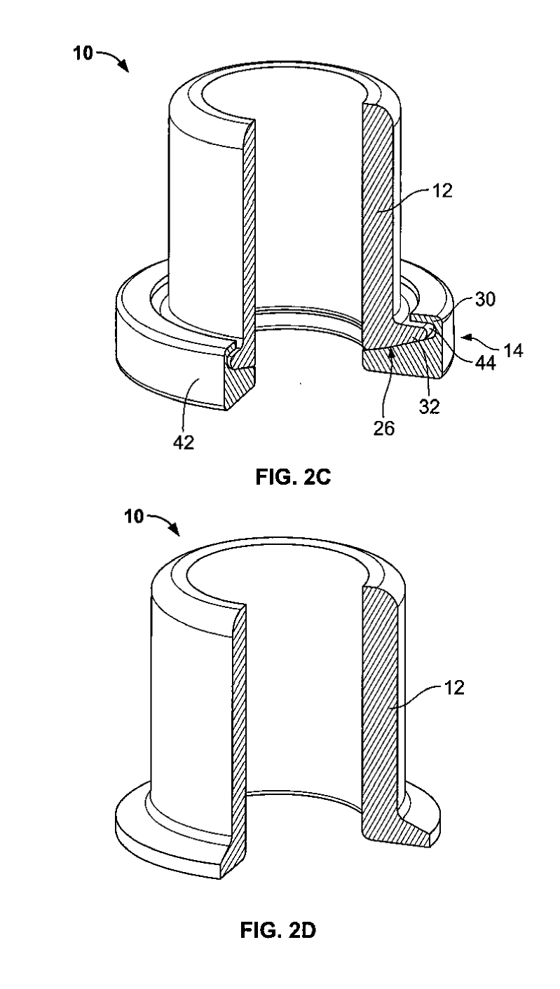

In a number of embodiments, materials for the soft, deformable collar body 12 may include, but are not limited to, aluminum and its alloys, such as 2099, 7075, 2024 and 6061. FIG. 3 is a graph showing a comparison of specific tensile strength (UTS/density) of various collar materials. In particular, in an embodiment, the graph shows that the specific tensile strength of aluminum 2099 compares favorably with other materials used to make collars.

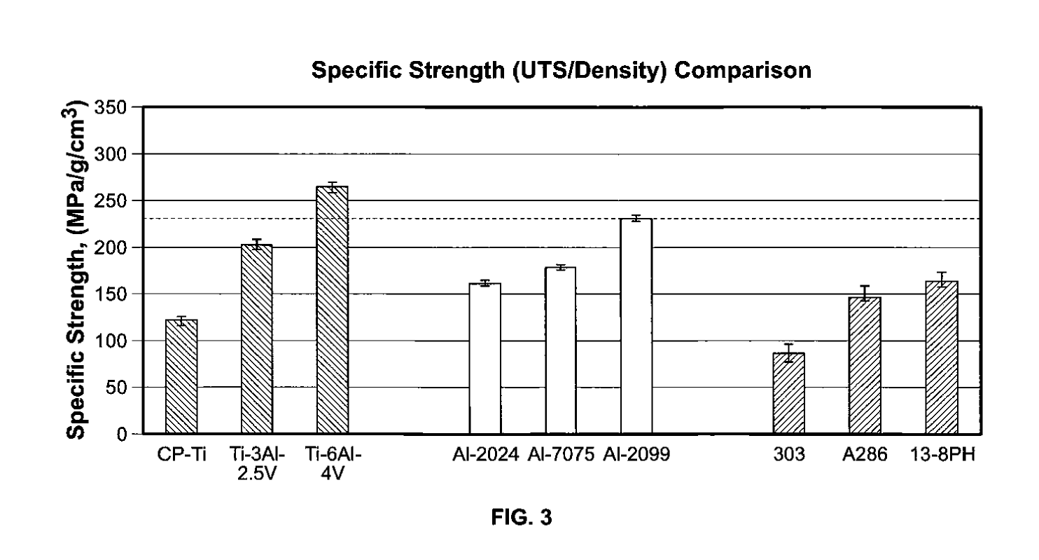

FIG. 4 illustrates an embodiment of a plurality of the collars 10 installed on a carbon fiber reinforced plastic (CFRP) workpiece.

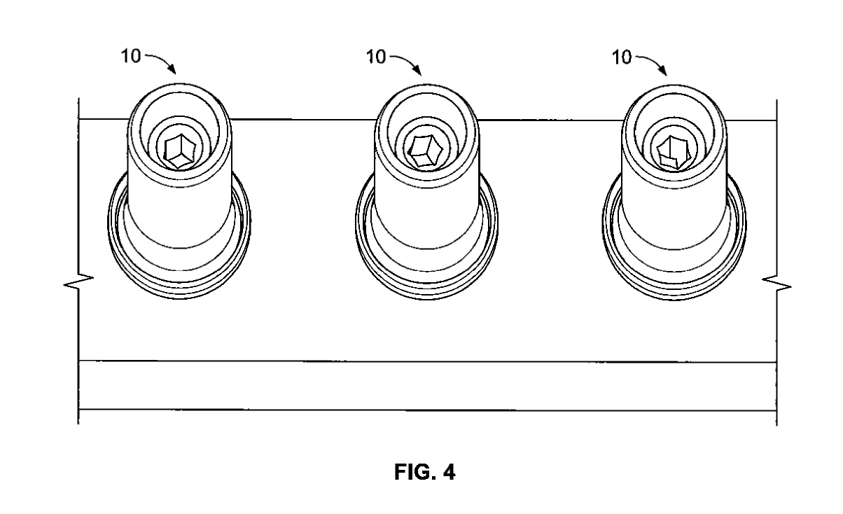

In an embodiment, the collar 10 may have a nano-grain structure achieved by cold working the collar 10 via in-situ forming process during fastener installation and creating a functional gradient material (FGM), as shown in FIG. 5. in an embodiment, this gradient in microstructure results in gradient in properties across the collar's 10 cross section and provides the necessary functional properties, namely, high tensile and shear strength approximately equal to those of titanium collars and higher corrosion resistance. In an embodiment, the degree of the cold working of the collar 10 is also controlled by varying an outside diameter of the collar 10 to provide a specified amount of deformed structure. In an embodiment, the specified collar outside diameter dimension for the collar's 10 size maintains the critical deformation needed for improved performance, but keeps it below levels that may lead to unintended cracking of the collar 10 during installation. In other embodiments, the FGM in other types of fasteners such as frangible collars, can be created by other means of cold working, such thread tapping or thread rolling operations.

In other embodiments, the collar 10 includes a coating comprising a combination of organic materials and non-conductive fillers. In an embodiment, the organic material of the coating can include the family of polymers, such as epoxies, and the non-conductive fillers can include aluminum pigmented or chromated paints and the family of sol-gel coatings. In one embodiment, the coating can be applied to every portion of the collar 10, specifically to the collar body 12. In other embodiments, the coating can be applied on the collar body 12 selectively, depending on desired joint performance. In another embodiment, the outer surface of the collar body 12 can include a coating comprised of a first material, and the inner surface of the collar body 12 can include a coating comprised of second material different from the first material.

In an embodiment, the collar 10 is electrically isolated from more noble structures, such as composite, by use of the close fitting base element 14, such as a captive washer inserted under and covering a bearing surface 26 of the collar body 12. In an embodiment, the base element 14 can be selected from a group of metallic materials which are known to be galvanically compatible to a composite structure. In an embodiment, these materials include steel, titanium, and their alloys. In other embodiments, other alloys and non-metallic materials may be used.

In an embodiment, the base element 14 not only provides protection from galvanic corrosion between the collar 10 and the CFRP structure, but plays an important role as one of the critical structural elements of the fastener system 16. In an embodiment, as shown in FIG. 2A, the base element 14 includes a flat base 28 that covers the bearing surface 26 of the collar body 12 and a securing portion 30 that is crimped and secured to a flange 32 of the collar body 12. In an embodiment, the securing portion 30 is angled obliquely relative to the base 28. In another embodiment, as shown in FIG. 2B, the base element 14 includes a ridge base 34 similar in structure to the base element 14 shown in FIG. 2A, but includes a sealing portion 36 that extends into the aperture 38 of the collar body 12 and partially covers an inner wall 40 thereof. In an embodiment, the sealing portion 36 acts as a seal for preventing moisture and other external elements from infiltrating the aperture 38 of the collar body 12. In another embodiment, as shown in FIG. 2C, the base element 14 includes a swivel base element 42, whereby a gap 44 or clearance is formed between the flange 32 of the collar body 12 and the securing portion 30, thereby allowing the swivel base element 42 to rotate relative to the collar body 12, and vice-versa. In an embodiment, the aforedescribed base elements 14 are rigid, and, therefore, they can accommodate any possible hole misalignment during fastener installation, thereby creating a self-aligning fastener. In an embodiment, in instances where the hole(s) of the workpieces 20, 22 is oversized or misaligned, the base element 14 fills any gaps between the holes and the pin 18 and assists in aligning the pin 18.

In an embodiment, the base element 14 mitigates composite bearing deformation when the collar 10 is used in a composite structure. In an embodiment, the base element 14 enables the collar body 12 to form during installation without direct contact with the structure. As a result, this prevents deformation (i.e., surface friction) of the collar 10 from translating into the structure.

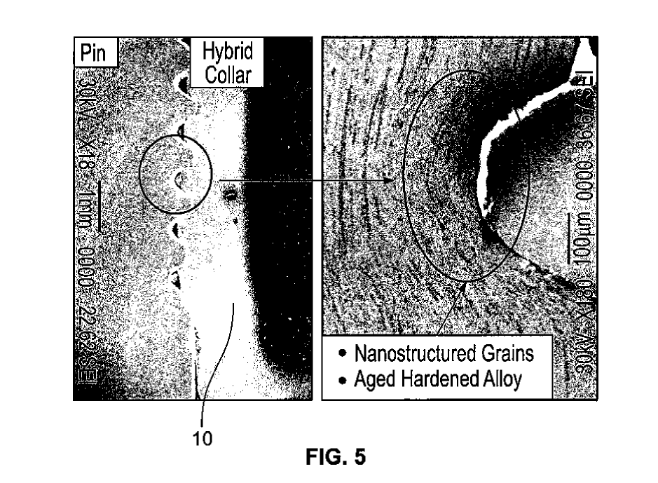

In an embodiment, the collar 10 is galvanically compatible for both metallic and composite structure applications, is lighter in weight, and is less expensive as compared to titanium fasteners, and have comparable strength to titanium fasteners, as shown in the graph of FIG. 6. In an embodiment, the collar 10 is about 30% to 50% lighter than comparable titanium collars, due to the lower density of the materials used for the collar body 12. In another embodiment, the collar 10 is about 40% lighter than comparable titanium collars.

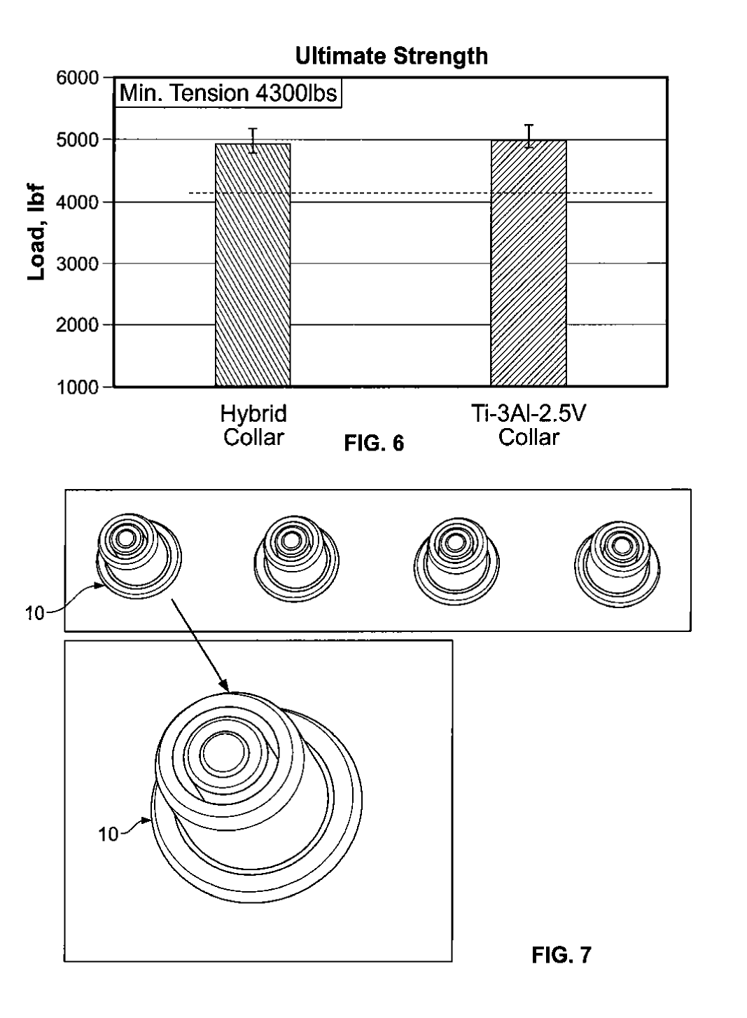

FIG. 7 illustrates an embodiment of a plurality of the collars 10 tested with a composite plate after salt spray corrosion testing. In an embodiment, the collars 10 show no evidence of any galvanic corrosion after a 250 hour salt spray exposure.

It will be understood that the embodiments described herein are merely exemplary and that a person skilled in the art may make many variations and modifications without departing from the spirit and scope of the invention. For instance, in an embodiment, the collar 10 can be a threaded member. In an embodiment, the collar 10 may be a lightly threaded collar having internal threads for aligning it on the threaded portion of the pin 18 and, thereafter, the collar 10 can be swaged onto the pin 18. In other embodiments, the collar 18 may include a single thread for the aforesaid alignment purposes, as disclosed in U.S. Pat. No. 4,867,625 to Dixon, which is incorporated by reference herein.

In another embodiment, the collar body 12 of the collar 10 may be a two-piece element, such that the elongated, tubular member of the collar body 12 is made from a soft, deformable material, such as aluminum and its alloys as described above, and the flange is made from a galvanically compatible material, such as titanium, steel, and their alloys as described above, and in which the tubular member and the flange are attached to one another. In on or more embodiments, the tubular member and the flange are attached to one another by friction welding, adhesives, or other suitable attachment means known in the art.

It should be understood that the embodiments described herein are merely exemplary and that a person skilled in the art may make many variations and modifications without departing from the spirit and scope of the invention. All such variations and modifications are intended to be included within the scope of the invention as defined in the appended claims.

What is claimed is:

1. A collar, comprising:
a collar body having a first end, a second end opposite the first end, and a flange located at the second end and having a bearing surface; and
a base element attached to the collar body, the base element including a base portion that covers the bearing surface of the collar body, and a securing portion that is joined to the flange of the collar body.

2. The collar of claim 1, wherein the collar body is made from a first material and the base element is made from a second material that is galvanically compatible with the first material.

3. The collar of claim 2, wherein the first material is selected from the group consisting of aluminum and aluminum alloys.

4. The collar of claim 3, wherein the second material is selected from the group consisting of steel, steel alloys, titanium, and titanium alloys.

5. The collar of claim 2, wherein the securing portion of the base element is crimped on the flange of the collar body.

6. The collar of claim 2, wherein the collar body includes an aperture extending from the first end to the second thereof and forming an inner wall, and wherein the base element includes a sealing portion that extends into the aperture of the collar body and covers a portion of the inner wall.

7. The collar of claim 2, wherein the base element includes a swivel base element that is adapted to rotate relative to the collar body.

8. The collar of claim 2, wherein the collar is adapted to be installed on a structure made of a composite material.

9. The collar of claim 2, further comprising a coating that includes an organic material and a non-conductive filler.

10. The collar of claim 7, wherein the organic material is a polymer material, and the non-conductive filler is selected from the group consisting of aluminum pigmented paint, chromated paint, and sol-gel coatings.

11. The collar of claim 9, wherein the coating is applied to every portion of the collar body.

12. The collar of claim 9, wherein the coating is be applied on the collar body selectively.

13. The collar of claim 2, wherein the collar is a threaded collar.

14. The collar of claim 2, wherein the collar is a swage collar.

15. A collar, comprising:
a collar body having a first end and a second end opposite the first end, the collar body being made from a first material; and
and a flange located at the second end of the collar body, the flange being made from a second material that is galvanically compatible with the first material.

16. The collar of claim 15, wherein the collar body and the flange are formed integrally with one another.

17. The collar of claim 16, wherein the first material is selected from the group consisting of aluminum and aluminum alloys.

18. The collar of claim 17, wherein the second material is selected from the group consisting of steel, steel alloys, titanium, and titanium alloys.
